(19) United States
(12) Patent Application Publication
(10) Pub. No.: US 2017/0195650 A1
(43) Pub. Date: Jul. 6, 2017

(54) METHOD AND SYSTEM FOR MULTI POINT SAME SCREEN BROADCAST OF VIDEO

(71) Applicants: Le Holdings (Beijing) Co., Ltd., Beijing (CN); Le Shi Zhi Xin Electronic Technology (Tianjin) Limited, Tianjin (CN)

(72) Inventor: Xuhua Liu, Binhai New Area (CN)

(21) Appl. No.: 15/241,229

(22) Filed: Aug. 19, 2016

Related U.S. Application Data
(63) Continuation of application No. PCT/CN2016/086572, filed on Jul. 10, 2016.

(30) Foreign Application Priority Data
Dec. 30, 2015 (CN) 201511029800.7

(51) Int. Cl. H04N 13/00; H04N 13/04; G06T 3/40; H04N 9/87

(52) U.S. Cl. CPC H04N 13/004; H04N 9/87; H04N 13/0445; H04N 13/0029; H04N 13/0459; G06T 3/40; G06T 2200/04; G06T 2207/20021

(57) ABSTRACT

Embodiments of the present disclosure relate to the field of virtual reality (VR) technologies, and disclose a video multipoint one-screen play method and an electronic device. In some embodiments of the present disclosure, by means of obtaining multiple display areas by dividing a display screen, a VR device is enabled to convert play formats of received video data when receiving the video data transmitted by multiple terminals, so as to enable a screen size of the video data to match a size of a display area, and fill the video data from each terminal on the entire display screen for display, thereby implementing 360° image seamless combination. Moreover, the VR device synchronously plays multiple pieces of video data by using the divided display areas, so as to implement 360° seamless play of the multiple pieces of video data, thereby providing better play experience for a user.

### CROSS-REFERENCE TO RELATED APPLICATIONS

The present disclosure is a continuation of PCT application No. PCT/CN2016/089572 submitted on Jul. 10, 2016. The present disclosure claims priority to Chinese patent application No. 2015110298007, filed with the Chinese Patent Office on Dec. 30, 2015 and entitled “VIDEO MULTIPOINT ONE-SCREEN PLAY METHOD AND system”, which is incorporated herein by reference in its entirety.

### TECHNICAL FIELD

This present disclosure relates to the field of virtual reality (VR) technologies, and more specifically, to a video multipoint one-screen play method and an electronic device.

### BACKGROUND

With the development of science and technologies, a VR device is widely used in projects, for example, military training, virtual driving, or virtual cities. A helmet project is a currently hot project. A most important characteristic of such a helmet project lies in 360-degree panorama display. The natural panorama display manner provides a good solution for one-screen display of different home entertainment terminals. However, the inventor finds, in a process of implementing the present disclosure, that currently, video data played on a helmet is customized video data. A terminal edits and processes a 360-degree scenario in advance, and then transmits the customized video data (for example, videos, games, or edited data) to a VR device for play. For example, for real-time scenarios such as a concert, for video data transmitted to the VR device, the terminal edits and processes, in real time, data acquired by a multi-angle camera. However, the VR device in the prior art can process only single piece of video data, and for real-time data in different scenarios, seamless play cannot be directly performed on the helmet currently, and the helmet has a simple function and poor user experience. For example, four different devices at home synchronously play different content, and currently, a method for synchronously playing the four paths of signals on a VR helmet is not provided.

### SUMMARY

This present disclosure provides a video multipoint one-screen play method and an electronic device, so that a VR device can play video data of multiple sources, so as to implement 360° seamless play of multiple pieces of video data, thereby providing better play experience for a user.

According to a first aspect, an embodiment of this present disclosure provides a video multipoint one-screen play method, applied in an VR device, including:
receiving video data transmitted in real time synchronously by at least two terminals;
dividing a display screen into several display areas;
converting, by the VR device, play formats of the video data from different terminals according to a result of dividing the display screen; and
synchronously projecting the video data from different terminals to different display areas for play, where video data from one terminal is projected to at least one display area.

According to a second aspect, an embodiment of this present disclosure provides a non-volatile computer storage medium, which stores a computer executable instruction, where execution of the computer executable instruction by the at least one processor causes the processor to execute the video multipoint one-screen play method.

According to a third aspect, an embodiment of this present disclosure provides an electronic device, including: at least one processor; and a memory for storing programs executable by the at least one processor, where execution of the programs by the at least one processor causes the at least one processor to execute any video multipoint one-screen play method of this application.

According to the video multipoint one-screen play method and the electronic device provided in the embodiments of this present disclosure, a VR device receives video data transmitted in real time synchronously by at least two terminals; a display screen is divided into several display areas, and play formats of the video data from different terminals are converted according to a result of dividing the display screen, and the video data from different terminals is synchronously projected to different display areas for play. Video data from one terminal is projected to at least one display area. By means of obtaining multiple display areas by dividing the display screen, the VR device is enabled to adjust the received video data when receiving the video data transmitted by multiple terminals, so as to enable a screen size of the video data to match a size of a display area, and fill the video data from each terminal on the entire display screen for display, thereby implementing 360° image seamless combination. Moreover, the VR device synchronously plays multiple pieces of video data by using the divided display areas, so as to implement 360° seamless play of the multiple pieces of video data, thereby providing better play experience for a user.

In an embodiment, in the step of dividing a display screen into several display areas, the display screen is divided equally according to a quantity of the terminals so that all areas of the display screen of the VR device can be used so as to avoid resource wastes. Moreover, in a case in which each display area has a same size, the dividing manner provides a current maximum screen width for each piece of video data.

In an embodiment, in the step of dividing a display screen into several display areas, the display screen is divided into display areas, a quantity of which is equal to that of the terminals, where sizes of the display areas are adjustable, and a size of a display area located in a direction directly facing a user is greater than sizes of display areas in other directions. In this way, video data being watched by a user has a large screen width, so as to provide a good viewing angle for the user, thereby improving watching experience of the user.

In an embodiment, when the video data from different terminals is synchronously projected to different display areas for play, played sounds correspond to a video played in the display area located in the direction directly facing the user, so as to avoid interference caused by sounds of other video data on sounds of the video data being watched by the user, thereby providing better play experience for the user.

In an embodiment, in the step of receiving video data transmitted in real time synchronously by at least two terminals, different terminals use different wireless transmission protocols to transmit data so as to improve a transmission speed of video data, so that the VR device can receive the video data as soon as possible, thereby providing possibilities for improving user experience.

### BRIEF DESCRIPTION OF THE DRAWINGS

One or more embodiments are exemplarily described by using figures that are corresponding thereto in the accompanying drawings; the exemplary descriptions do not form a limitation to the embodiments. Elements with same reference signs in the accompanying drawings are similar elements. Unless otherwise particularly stated, the figures in the accompanying drawings do not form a scale limitation.

FIG. 1 is a flowchart of a video multipoint one-screen play method according to Embodiment 1 of the present disclosure;

FIG. 2 is a schematic diagram of a terminal of a video multipoint one-screen play system according to Embodiment 3 of the present disclosure;

FIG. 3 is a schematic structural diagram of an electronic device according to Embodiment 3 of the present disclosure; and

FIG. 4 is a schematic structural diagram of an electronic device according to Embodiment 6 of this application.

### DETAILED DESCRIPTION

To make the objective, technical solutions, and advantages of this application more clear, the following clearly and completely describes the technical solutions of this application by means of implementation manners with reference to the accompanying drawings of embodiments of this application. Obviously, the described embodiments are only some embodiments, rather than all embodiments of this application.

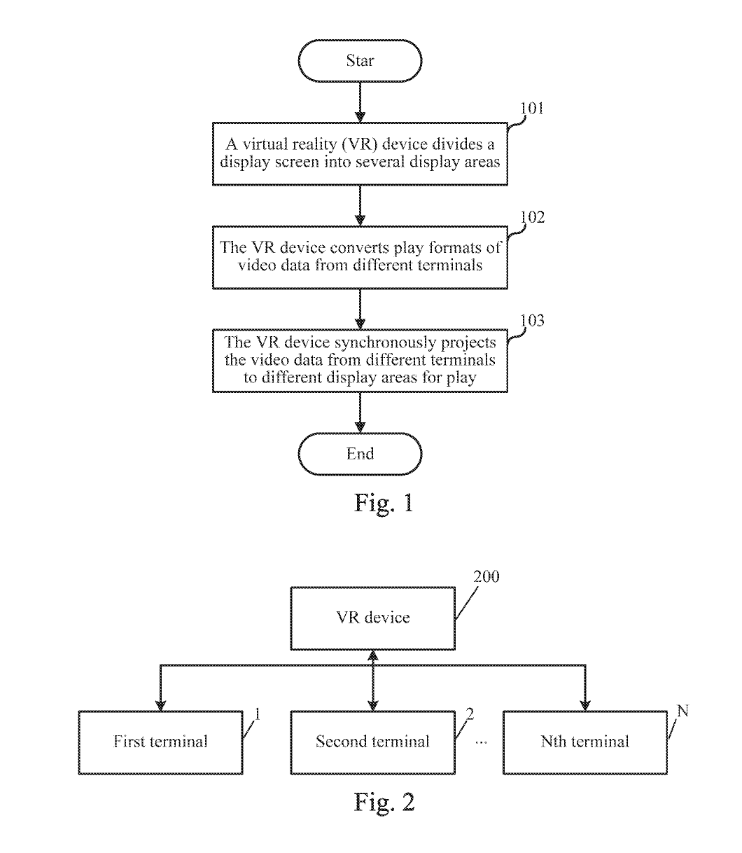

Embodiment 1 of the present disclosure relates to a video multipoint one-screen play method, and a specific process is shown in FIG. 1. An application scenario of the present implementation manner is: receiving video data transmitted in real time synchronously by at least two terminals, for example, a user is using at least two terminals to transmit video data to a VR device in real time synchronously, where the terminals may be electronic devices, for example, a computer, a mobile phone, a tablet computer, a camera, a television, or a video box; the terminals may transmit the video data by using a data line, or may transmit the video data by using a wireless transmission protocol. The examples are not intended to make any limitation herein. As a display terminal and a processing terminal, the VR device combines and processes all data from different terminals, so as to achieve 360-degree image seamless combination between different devices.

Step 101, divide a display screen into several display areas.

A dividing quantity of a display screen may be default setting in the VR device; a value in the default setting may be preset and stored in the VR device by a user or a manufacturer.

However, in the present implementation manner, the display screen is divided equally according to a quantity of the terminals so that all areas of the display screen of the VR device can be used so as to avoid resource wastes. Moreover, in a case in which each display area has a same size, the dividing manner provides a current maximum screen width for each piece of video data. For example, a VR helmet and multiple terminals are used as an example.

1. Suppose 6 different devices play 6 programs synchronously, and in this case, data of the 6 devices is synchronously transmitted to the VR helmet, that is, video data transmitted in real time synchronously by 6 terminals is received, and in this way, each path of device occupies a 60-degree image, and programs of different scenarios can be watched always and everywhere.

2. Suppose 4 different devices play 4 programs synchronously, and in this case, data of the 4 devices is synchronously transmitted to the VR helmet, that is, video data transmitted in real time synchronously by 4 terminals is received, and in this way, each path of device occupies a 90-degree image, and programs of different scenarios can be watched always and everywhere.

3. Suppose 3 different devices play 3 programs synchronously, and in this case, data of the 3 devices is synchronously transmitted to the VR helmet, that is, video data transmitted in real time synchronously by 3 terminals is received, and in this way, each path of device occupies a 120-degree image, and programs of different scenarios can be watched always and everywhere.

4. Suppose 2 different devices play 2 programs synchronously, and in this case, data of the 2 devices is synchronously transmitted to the VR helmet, that is, video data transmitted in real time synchronously by 2 terminals is received, and in this way, each path of device occupies a 180-degree image, and programs of different scenarios can be watched always and everywhere.

Step 102, convert play formats of video data from different terminals.

Because play formats of videos played by different terminals are different, to enable the video data from different terminal to be adapted to play by the VR device, format conversion needs to be performed. The play format conversion herein includes but is not limited to: arbitrary size scaling, video file format conversion, arbitrary arrangement of locations of videos, and the like. For example, the VR device adjusts the received video data according to sizes of divided display areas, so as to enable a screen size of the video data to match a size of a display area, and fill the video data from each terminal on the entire display screen, thereby implementing 360° image seamless combination. For another example, a display area is split so as to be adapted to video requirements of more terminals.

Step 103, synchronously project the video data from different terminals to different display areas for play.

Specifically, the VR device synchronously projects the video data from different terminals to each divided display area separately for play. The video data played by the VR device may carry sounds.

It is worth mentioning that when the video data played by the VR device carries sounds, then sounds currently played by the VR device correspond to a video played in a display area located in a direction directly facing a user, so as to avoid interference caused by sounds of other video data on sounds of the video data being watched by the user, thereby providing better play experience for the user. A method for acquiring the direction directly facing the user may be that: the user selects the display area in the direction directly facing the user himself; or a location sensor and a Dolby stereoscopic Atmos technology are provided on the VR device, and the location sensor is used to detect the direction directly facing the user, and therefore the user can hear only video sounds in the direction directly facing the user, thereby avoiding interference between different video content, and achieving perfect experience. In the present implementation manner, only the foregoing method is used as an example; and any method for acquiring the direction directly facing the user is within the protection scope of the present disclosure.

It is not difficult to see that, in the present implementation manner, by means of obtaining multiple display areas by dividing a display screen, a VR device is enabled to combine and process received video data when receiving the video data transmitted by multiple terminals, so as to enable a screen size of the video data to match a size of a display area, and fill the video data from each terminal on the entire display screen for display, thereby implementing 360° image seamless combination. Moreover, the VR device synchronously plays multiple pieces of video data by using the divided display areas, so as to implement seamless play of the multiple pieces of video data, thereby providing better play experience for a user.

Moreover, it is worth mentioning that in a process of transmitting, by multiple terminals, the video data to the VR device in real time synchronously, a same transmission protocol may be used to perform transmission, or some terminals may use a same transmission protocol to perform transmission, and other terminals use different transmission protocols to perform transmission, or different terminals may be further enabled to use different wireless transmission protocols to transmit the video data to the VR device. That is, the VR device can perform data transmission with the terminals by using same or multiple transmission protocols according to requirements, so that the VR device can receive the video data as soon as possible, thereby providing possibilities for improving user experience. For example, the VR device has a Bluetooth module and a wireless network interface card, and then a mobile phone can establish a Bluetooth communications connection with the VR module by using the Bluetooth module, so as to perform data transmission. At the same time, a computer can establish a wireless local area network with the VR device, so as to perform data transmission. In this way, the VR device uses multiple interfaces to receive the video data synchronously, so as to implement concurrent uploading of multiple pieces of video data, thereby effectively shortening time needed by transmission of multiple pieces of video data. Moreover, this application makes no limitation to specific types of transmission protocols, and all current transmission protocols can be used in this application.

The step divisions of the foregoing various methods are only for description clearness, and in implementation, the steps can be combined into one step, or some steps can be decomposed into multiple steps for each; as long as the steps include the same logic relationship, the steps are within the protection scope of the present patent; adding insignificant modifications or introducing insignificant designs into an algorithm or a process does not change core designs of the algorithm or process, where the core designs of the algorithm or process are within the protection scope of the patent.

Embodiment 2 of this application relates to a video multipoint one-screen play method. Embodiment 2 is an improvement based on Embodiment 1, and the improvement mainly lies in: in Embodiment 2, sizes of display areas are adjustable, and a size of a display area, which is located in a direction directly facing a user, of a VR device is greater than sizes of display areas in other directions, so as to provide a good viewing angle for the user, thereby improving watching experience of the user.

In the present implementation manner, the VR device divides a display screen into display areas, a quantity of which is equal to that of terminals, where sizes of the display areas are adjustable, which provides possibilities for satisfying user watching requirements.

A user can manually adjust the sizes of the display areas. For example, the user sends an adjusting instruction to the VR device by using a control apparatus, and the VR device adjusts the sizes of the display areas according to the received adjusting instruction, so as to satisfy the user watching requirements. Alternatively, the display area in the direction directly facing the user is set to be larger by default, and equal display is performed in other directions. Once a video turns to the direction directly facing the user, the display area is enlarged, and the display area in the previous direction directly facing the user is reduced, so that the display area in the direction directly facing the user always keeps a good size, so as to provide good watching experience for the user.

Moreover, in the present implementation manner, the size of the display area, which is located in the direction directly facing the user, of the VR device is enabled to be greater than the sizes of the display areas in other directions, so that video data being watched by the user has a large screen width, so as to provide a good viewing angle for the user, thereby improving watching experience of the user. For example, currently scientific experiments find that: an overlapped visual field of two human eyes of is 124°; within a range seen by the human eyes, only objects within a 124° angle of view have stereoscopic sensation. A limit of the angle of view of the human eyes is about 150 degrees in a vertical direction, and 230 degrees in a horizontal direction. If a screen fills a range of the angle of view to the full, people will have immersive viewing experience. Therefore, the size of the display area, which is in the direction directly facing the user, and is provided by VR device for the user may be 150 degrees in the vertical direction, and 230 degrees in the horizontal direction, so that the user has strong watching sense of reality, thereby obtaining good watching experience.

Embodiment 3 of the present disclosure relates to a video multipoint one-screen play system, as shown in FIG. 2, including: a VR device 200 and at least two terminals (1, 2 . . . N), where the at least two terminals transmit video data to the VR device in real time synchronously.

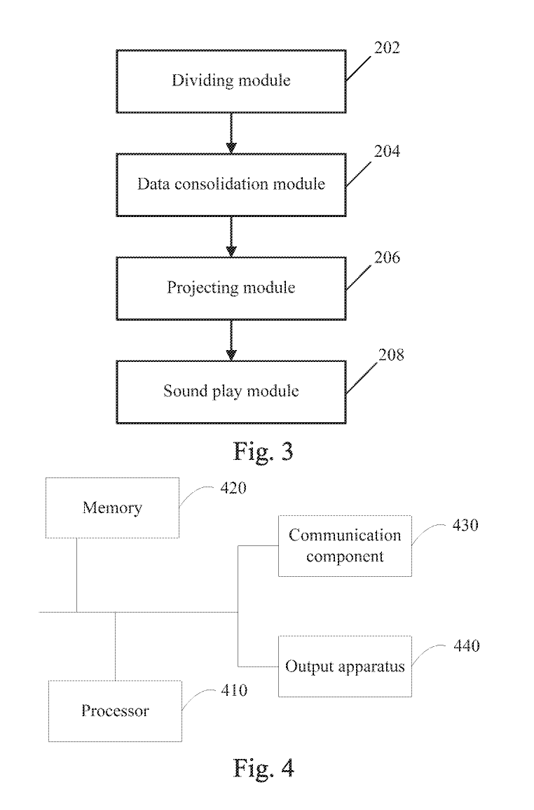

As shown in FIG. 3, the VR device 200 includes: a dividing module 202, a data consolidation module 204, a projecting module 206, and a sound play module 208, as shown in FIG. 3. The dividing module 202 is configured to divide a display screen into several display areas. In the present implementation manner, the dividing module 202 can divide the display screen equally according to a quantity of terminals. The data consolidation module 204 is configured to convert play formats of data from different terminals according to a result of dividing the display screen. The projecting module 206 is configured to synchronously project the video data from different terminals to different display areas for play, where video data from one terminal is projected to at least one display area. Sounds played by the sound play module 208 correspond to a video played in a display area located in a direction directly facing a user.

It is not difficult to find that this embodiment is a system embodiment corresponding to Embodiment 1. This embodiment can be implemented in cooperation with Embodiment 1. Relevant technical details mentioned in Embodiment 1 are still effective in this embodiment. To reduce repetition, details are not described herein again. Correspondingly, relevant technical details mentioned in this embodiment can also be applied in Embodiment 1.

It is worth mentioning that the modules involved in the present implementation manner are all logic modules. In actual application, a logic unit may be a physical unit, or may also be a part of a physical unit, or may further be implemented by using a combination of multiple physical units. Moreover, to highlight an innovative part of the present disclosure, the present implementation manner does not introduce units that are not closely related to resolving the technical problem proposed in the present disclosure. However, it does not indicate that other units do not exist in the present implementation manner.

Embodiment 4 of this application relates to a video multipoint one-screen play system. Embodiment 4 is an improvement based on Embodiment 3, and the improvement mainly lies in: in Embodiment 4, a dividing module divides a display screen into display areas, a quantity of which is equal to that of terminals; wherein sizes of the display areas are adjustable, and a size of a display area located in a direction directly facing a user is greater than sizes of display areas in other directions.

Because Embodiment 2 corresponds to this embodiment, this embodiment can be implemented in cooperation with Embodiment 2. Relevant technical details mentioned in Embodiment 2 are still effective in this embodiment, and technical effects that can be achieved in Embodiment 2 can also be implemented in this embodiment. To reduce repetition, details are not described herein again. Correspondingly, relevant technical details mentioned in this embodiment can also be applied in Embodiment 2.

The steps of a method or an algorithm described in combination with embodiments disclosed herein may be directly embodied in hardware, in a software module executed by a processor, or in a combination of the two. The software module may reside in a random access memory (RAM), a flash memory, a read only memory (ROM), a programmable read only memory (PROM), an erasable read only memory (PROM), an erasable programmable read only memory (EPROM), an electrically erasable programmable read only memory (EEPROM), a register, a hard disk, a removable disk, a compact disc read-only memory (CD-ROM), or a storage medium in any other form known in the art. In the alternative, the storage medium may be integral to the processor. The processor and the storage medium may reside in an application-specific integrated circuit (ASIC). The ASIC may reside in a calculation apparatus or a user terminal. In the alternative, the processor and the storage medium may reside as discrete components in the calculation apparatus or the user terminal.

Embodiment 5 of this application provides a non-volatile computer storage medium, which stores a computer executable instruction, where the computer executable instruction can execute the video multipoint one-screen play method in any one of the foregoing method embodiments.

FIG. 4 is a schematic structural diagram of hardware of an electronic device for executing a video multipoint one-screen play method according to Embodiment 6 of this application. As shown in FIG. 4, the device includes:

one or more processors 410 and a memory 420, where only one processor 410 is used as an example in FIG. 4.

An electronic device for executing the video multipoint one-screen play method may further include: a communication component 430 and an output apparatus 440.

The processor 410, the memory 420, the communication component 430, and the output apparatus 440 can be connected by means of a bus or in other manners. A connection by means of a bus is used as an example in FIG. 4.

As a non-volatile computer readable storage medium, the memory 420 can be used to store non-volatile software programs, non-volatile computer executable programs and modules, for example, a program instruction/module corresponding to the video multipoint one-screen play method in the embodiments of this application (for example, the dividing module 202, the data consolidation module 204, the projecting module 206, and the sound play module 208 shown in FIG. 3). The processor 410 executes various functional applications and data processing of the server, that is, implements the video multipoint one-screen play method of the foregoing method embodiments, by running the non-volatile software programs, instructions, and modules that are stored in the memory 420.

The memory 420 may include a program storage area and a data storage area, where the program storage area may store an operating system and an application that is needed by at least one function; the data storage area may store data created according to use of the video multipoint one-screen play method, and the like. In addition, the memory 420 may include a high-speed random access memory, or may also include a non-volatile memory such as at least one disk storage device, flash storage device, or another non-volatile solid-state storage device. In some embodiments, the memory 420 optionally includes memories that are remotely disposed with respect to the processor 410, and the remote memories may be connected, via a network, to the VR device. Examples of the foregoing network include but are not limited to: the Internet, an intranet, a local area network, a mobile communications network, or a combination thereof.

The communication component 430 is used to implement a wireless or wired communication function of the VR device, so that the VR device can interact with a video device, so as to facilitate receiving, in real time synchronously, from the video device, video data to be played.

The output apparatus 440 may include a display device, for example, a display screen, for synchronously projecting video data from different terminals to different display screens for play.

The one or more modules are stored in the memory 420; when the one or more modules are executed by the one or more processors 410, the video multipoint one-screen play method in any one of the foregoing method embodiments is executed.

The foregoing product can execute the method provided in the embodiments of this application, and has corresponding functional modules for executing the method and beneficial effects. Refer to the method provided in the embodiments of this application for technical details that are not described in detail in this embodiment.

The electronic device in this embodiment of this application exists in multiple forms, including but not limited to:

(1) Mobile communication device: such devices are characterized by having a mobile communication function, and primarily providing voice and data communications; terminals of this type include: a smart phone (for example, an iPhone), a multimedia mobile phone, a feature phone, a low-end mobile phone, and the like;

(2) Ultra mobile personal computer device: such devices are essentially personal computers, which have computing and processing functions, and generally have the function of mobile Internet access; terminals of this type include: PDA, MID and UMPC devices, and the like, for example, an iPad;

(3) Portable entertainment device: such devices can display and play multimedia content; devices of this type include: an audio and video player (for example, an iPod), a handheld game console, an e-book, an intelligent toy and a portable vehicle-mounted navigation device;

(4) Server: a device that provides a computing service; a server includes a processor, a hard disk, a memory, a system bus, and the like; an architecture of a server is similar to a universal computer architecture. However, because a server needs to provide highly reliable services, requirements for the server are high in aspects of the processing capability, stability, reliability, security, extensibility, and manageability; and

(5) other electronic apparatuses having a data interaction function.

The apparatus embodiment described above is merely exemplary, and units described as separated components may be or may not be physically separated; components presented as units may be or may not be physical units, that is, the components may be located in a same place, or may be also distributed on multiple network units. Some or all modules therein may be selected according to an actual requirement to achieve the objective of the solution of this embodiment.

Through description of the foregoing implementation manners, a person skilled in the art can clearly learn that each implementation manner can be implemented by means of software in combination with a universal hardware platform, and certainly, can be also implemented by using hardware. Based on such understanding, the essence, or in other words, a part that makes contributions to relevant technologies, of the foregoing technical solutions can be embodied in the form of a software product. The computer software product may be stored in a computer readable storage medium, for example, a ROM/RAM, a magnetic disk, or a compact disc, including several instructions for enabling a computer device (which may be a personal computer, a sever, or a network device, and the like) to execute the method in the embodiments or in some parts of the embodiments.

Finally, it should be noted that: the foregoing embodiments are only used to describe the technical solutions of this application, rather than limit this application. Although this application is described in detail with reference to the foregoing embodiments, a person of ordinary skill in the art should understand that he/she can still modify technical solutions disclosed in the foregoing embodiments, or make equivalent replacements to some technical features therein; however, the modifications or replacements do not make the essence of corresponding technical solutions depart from the spirit and scope of the technical solutions of the embodiments of this application.

1. A video multipoint one-screen play method, applied in a VR device, comprising:
receiving video data transmitted in real time synchronously by at least two terminals;
dividing a display screen into several display areas;
converting play formats of the video data from different terminals according to a result of dividing the display screen; and
synchronously projecting the video data from different terminals to different display areas for play, wherein video data from one terminal is projected to at least one display area.

2. The video multipoint one-screen play method according to claim 1, wherein in the step of dividing a display screen into several display areas, the display screen is divided equally according to a quantity of the terminals.

3. The video multipoint one-screen play method according to claim 1, wherein in the step of dividing a display screen into several display areas, the display screen is divided into display areas, a quantity of which is equal to that of the terminals.
sizes of the display areas are adjustable, and a size of a display area located in a direction directly facing a user is greater than sizes of display areas in other directions.

4. The video multipoint one-screen play method according to claim 1, wherein when the video data from different terminals is synchronously projected to different display areas for play, played sounds correspond to a video played in the display area located in the direction directly facing the user.

5. (canceled)

6. The video multipoint one-screen play method according to claim 1, wherein in the step of receiving video data transmitted in real time synchronously by at least two terminals, different terminals use different wireless transmission protocols to transmit data.

7-11. (canceled)

12. A non-volatile computer storage medium, which stores computer executable instructions, wherein the computer executable instructions are configured to:
receive video data transmitted in real time synchronously by at least two terminals;
divide a display screen into several display areas;
convert play formats of the video data from different terminals according to a result of dividing the display screen; and
synchronously project the video data from different terminals to different display areas for play, wherein video data from one terminal is projected to at least one display area.

13. The non-volatile computer storage medium according to claim 12, wherein to divide a display screen into several display areas, the display screen is divided equally according to a quantity of the terminals.

14. The non-volatile computer storage medium according to claim 12, wherein
to divide a display screen into several display areas, the display screen is divided into display areas, a quantity of which is equal to that of the terminals;
sizes of the display areas are adjustable, and a size of a display area located in a direction directly facing a user is greater than sizes of display areas in other directions.

15. The non-volatile computer storage medium according to claim 12, wherein
when the video data from different terminals is synchronously projected to different display areas for play, played sounds correspond to a video played in the display area located in the direction directly facing the user.

16. The non-volatile computer storage medium according to claim 12, wherein
to transmit, by at least two terminals, video data to a VR device in real time synchronously, different terminals use different wireless transmission protocols to transmit data.

17. An electronic device, comprising: at least one processor; and
a memory communicably connected with the at least one processor for storing instructions executable by the at least one processor, wherein execution of the instructions by the at least one processor causes the at least one processor to:
receive video data transmitted in real time synchronously by at least two terminals;
divide a display screen into several display areas;
convert play formats of the video data from different terminals according to a result of dividing the display screen; and
synchronously project the video data from different terminals to different display areas for play, wherein video data from one terminal is projected to at least one display area.

18. The electronic device according to claim 17, wherein to receive video data transmitted in real time synchronously by at least two terminals, the display screen is divided equally according to a quantity of the terminals.

19. The electronic device according to claim 17, wherein to divide dividing a display screen into several display areas, the display screen is divided into display areas, a quantity of which is equal to that of the terminals;
wherein sizes of the display areas are adjustable, and a size of a display area located in a direction directly facing a user is greater than sizes of display areas in other directions.

20. The electronic device according to claim 17, wherein when the video data from different terminals is synchronously projected to different display areas for play, played sounds correspond to a video played in the display area located in the direction directly facing the user.

21. The electronic device according to claim 17, wherein to receive video data transmitted in real time synchronously by at least two terminals, different terminals use different wireless transmission protocols to transmit data.
